(19) United States
(12) Patent Application Publication
(10) Pub. No.: US 2026/0050919 A1
(43) Pub. Date: Feb. 19, 2026

(54) METHODS AND SYSTEMS FOR EXCHANGING CONFIDENTIAL INFORMATION USING DECENTRALIZED IDENTIFIERS VIA A BLOCKCHAIN

(71) Applicant: Wolters Kluwer DXG U.S., Inc., Riverwoods, IL (US)

(72) Inventors: Adam Jason Orentlicher, Apex, NC (US); Fabio Bagatin, Varese (IT)

(21) Appl. No.: 18/802,245

(22) Filed: Aug. 13, 2024

(51) Int. Cl. G06Q 20/40; H04L 9/40

(52) U.S. Cl. CPC G06Q 20/401; H04L 63/0435

(57) ABSTRACT

Systems and methods for securely accessing information pertaining to an upstream entity using a verifiable credential with an embedded distributed identifier includes generating an authorization request for access to the information by a downstream entity. The authorization request includes a decentralized identifier associated with the downstream entity and is transmitted to a content storage entity. An authorization notification corresponding to the authorization request is received. An authorization token is retrieved. The authorization token includes a verifiable credential generated by the upstream entity and incorporating the decentralized identifier. A request transaction including a request to access the information pertaining to the upstream entity and the authorization token is generated and transmitted to the content storage entity. A verification challenge corresponding to the request transaction based on the verifiable credential is received and a response is transmitted. A reply transaction is received granting access to the information pertaining to the upstream entity.

### TECHNICAL FIELD

This application relates generally to electronic exchange of confidential data, and more particularly, to utilizing verifiable credentials for information access.

### BACKGROUND

A confirmation process generally involves a confirming entity tasked with determining whether information provided by a target entity is accurate. The confirming entity typically reaches out to a third party to provide evidence regarding the target entity's information. However, such information is often confidential, making it challenging to exchange information among parties, verify the information, and maintain data privacy. In order to facilitate exchange of confidential information, current systems utilize centralized (e.g., federated, local, etc.) identity management systems.

Although centralized systems for exchanging confidential information allow for transfer of confidential information, the generation and use of centralized credentials creates opportunities for fraud, unintentional data exposure, misassigned credentials, and other security issues. For example, centralized credentials may be subject to theft via social engineering or network intrusions, allowing unauthorized actors to access and extract confidential information using acquired credentials. Further, when an unauthorized access occurs, it may be difficult to trace the individual responsible for the unauthorized access or distribution of confidential information.

### SUMMARY

In various embodiments, a system including a non-transitory memory and a processor communicatively coupled to the non-transitory memory is disclosed. The processor is configured to read a set of instructions to generate an authorization request for access to information pertaining to a target entity and a blockchain address of the target entity, transmit the authorization request to a smart contract deployed on the blockchain, detect an indication that an authorization notification corresponding to the authorization request has been received via the smart contract, retrieve an authorization token based on at least a portion of the authorization notification, generate a request transaction including a request to verify the information pertaining to the target, a blockchain address of a third party to which the request is directed, and the authorization token, provide the request transaction to the smart contract deployed on the blockchain, detect an indication that a reply transaction corresponding to the request transaction has been received via the smart contract, and retrieve the reply transaction via the smart contract to determine whether the third party has verified the information.

In various embodiments, a computer-implemented method is disclosed. The computer-implemented method includes steps of generating an authorization request for access to information pertaining to a target entity and a blockchain address of the target entity, transmitting the authorization request to a smart contract deployed on the blockchain, detecting an indication that an authorization notification corresponding to the authorization request has been received via the smart contract, retrieving an authorization token based on at least a portion of the authorization notification, generating a request transaction including a request to verify the information pertaining to the target, a blockchain address of a third party to which the request is directed, and the authorization token, providing the request transaction to the smart contract deployed on the blockchain, detecting an indication that a reply transaction corresponding to the request transaction has been received via the smart contract, and retrieving the reply transaction via the smart contract to determine whether the third party has verified the information.

In various embodiments, a non-transitory computer readable medium having instructions stored thereon is disclosed. The instructions, when executed by at least one processor, cause at least one device to perform operations including generating an authorization request for access to information pertaining to a target entity and a blockchain address of the target entity, transmitting the authorization request to a smart contract deployed on the blockchain, detecting an indication that an authorization notification corresponding to the authorization request has been received via the smart contract, retrieving an authorization token based on at least a portion of the authorization notification, generating a request transaction including a request to verify the information pertaining to the target, a blockchain address of a third party to which the request is directed, and the authorization token, providing the request transaction to the smart contract deployed on the blockchain, detecting an indication that a reply transaction corresponding to the request transaction has been received via the smart contract, and retrieving the reply transaction via the smart contract to determine whether the third party has verified the information.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to utilize verifiable credentials including embedded decentralized identifiers for authorizing access to confidential information via a blockchain, in accordance with some embodiments;

FIG. 2 is a flowchart illustrating a method of operation of the network environment of FIG. 1 including interactions with a blockchain, in accordance with some embodiments;

FIGS. 3A-3B illustrate messaging diagrams of an example scenario in which a downstream entity requests access to confidential information associated with an upstream entity, in accordance with some embodiments;

FIGS. 4A-4B illustrate messaging diagrams of an example scenario in which a downstream entity access confidential information maintained by a content storage entity and associated with an upstream entity utilizing an authorization token including a verifiable credential having an embedded decentralized identifier for verification, in accordance with some embodiments; and

FIG. 5 illustrates a computer system configured to implement one or more processes, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Using the techniques of this disclosure, a first entity (e.g., a downstream entity) can access information regarding a second entity (e.g., upstream entity) that is maintained by a third entity (e.g., content storage entity) without use of centralized identifiers or the need for the content storage entity to generate credentials for the downstream entity. The content storage entity, for instance, may maintain information regarding the upstream entity or on behalf of the upstream entity. The techniques of this disclosure can be applied in any relevant industry or process in which information needs to be exchanged and/or verified while maintaining the confidentiality of the information. As one example, a confirmation process may involve a financial audit, in which an auditor (e.g., downstream entity) requests confirmation from a third party (e.g., content storage entity), such as a bank or financial institution, regarding information of a client, the audited entity (e.g., upstream entity). During an audit, the auditor may seek to confirm information received from the client, such as a bank account balance, by verifying the information with the financial institution where the bank account is held. The auditor also may seek to verify information regarding the client that is held by other entities, which may hold accounts receivable or accounts payable pertaining to the client. Auditors may also use the disclosed techniques to obtain or verify information maintained by other auditors. Similarly, another example confirmation process may be a compliance audit, which may be an external audit performed by an outside entity (e.g., a regulator) or an internal audit performed by entities of the audited entity itself. As a further example, the disclosed techniques may be used by medical professionals or insurance providers to exchange and verify patient health information. For instance, a healthcare payer may seek to verify confidential information of a patient that is held by the patient's doctor. Likewise, a first doctor may seek to verify or obtain patient medical records held by a second doctor. Accordingly, the techniques of this disclosure can be applied in any arrangement in which one or more parties seek to verify or confirm information.

The computing system of this disclosure may utilize a blockchain in order to exchange information between the parties. It should be also appreciated that while this disclosure primarily refers to a “blockchain,” a blockchain is an example type of distributed ledger. A distributed ledger is a storage mechanism for data, events, transactions, etc. that is maintained by several participants. More specifically, a distributed ledger is a way of achieving a distributed consensus on the validity or invalidity of information recorded in the distributed ledger. In other words, the distributed ledger provides a decentralized trust to participants and observers. As opposed to relying on a central authority, a distributed ledger is a decentralized database in which a transactional record of changes to the ledger is maintained and validated by each node of a peer-to-peer network. A blockchain is an example type of distributed ledger, in which groupings of transactions are organized together into a “block” and ordered sequentially (thus the term “blockchain”). Thus, while the distributed ledgers discussed herein are referred to in the context of a blockchain, this is merely one example of a distributed ledger. The techniques of this disclosure could be applied to other types of distributed ledgers besides blockchains and/or may be applied to information exchanges outside of a blockchain (e.g., direct information exchanges).

The nodes that share the ledger may form what is referred to herein as the blockchain network. The nodes in the blockchain network may validate changes to the blockchain (e.g., when a new transaction and/or block is created) according to a set of consensus rules. The consensus rules may depend on the information being tracked by the blockchain, and may include rules regarding the chain itself. For example, a consensus rule may require an originator of a change (e.g., an entity that submits a transaction to the blockchain) to supply a proof-of-identify (e.g., a digital signature), such that only approved entities may originate changes. A consensus rule may require that blocks and transactions adhere to format requirements and supply certain meta information regarding any changes (e.g., blocks must be below a size limit, transactions must include a number of fields, etc.). Consensus rules may include a mechanism to determine the order in which new blocks are added to the chain (e.g., through proof-of-work, proof-of-stake, proof-of-authority, proof-of-space, or other suitable consensus algorithm).

Additions to the blockchain that satisfy the consensus rules may be propagated from nodes that have validated the addition to other nodes that the validating node is aware of. If all the nodes that receive a change to the blockchain validate the new block, then the blockchain may reflect the new change as stored on all nodes, and it may be said that distributed consensus has been reached with respect to the new block and the information contained therein. Any change that does not satisfy the consensus rules may be disregarded by validating nodes that receive the change, which refrain from propagating the change to other nodes. Accordingly, unlike a traditional system which relies on a central authority, a single party cannot unilaterally alter the blockchain unless the single party can do so in a way that satisfies the consensus rules. Further, while nodes may add transactions to the blockchain, past transactions are not erased from the ledger. Accordingly, there remains on the blockchain a verifiable and permanent record of past transactions and the entities that originated past transactions. The inability to modify past transactions leads to blockchains being generally described as trusted, secure, and immutable.

Generally speaking, validation activities of nodes applying consensus rules on a blockchain network may take various forms. In this disclosure, validating nodes may execute code contained in “smart contracts” and distributed consensus may be expressed as the nodes agreeing on the output of the executed code.

A smart contract is a computer protocol that enables the automatic execution and/or enforcement of an agreement between different parties. In particular, the smart contract may be computer code that is located at a particular address on the blockchain and that may be executed by nodes supporting the blockchain. In some cases, the smart contract may run automatically in response to a participant in the blockchain sending funds (e.g., cryptocurrency such as bitcoin, ether, or other digital/virtual currency) and/or data to the address where the smart contract is stored. The smart contract may include one or more trigger conditions that, when satisfied, correspond to one or more actions. For some smart contracts, which action(s) from the one or more actions are performed may be determined based upon one or more decision conditions. In some instances, data streams may be routed to the smart contract so that the smart contract may detect that a trigger condition has occurred, and/or analyze a decision condition.

For example, a smart contract may define a collection of variables, where the values of the variables are referred to as the “state” of the smart contract. The values are stored in a state database of the blockchain. Each node may maintain a copy of the state database, which reflects current values of the variables, i.e., the current state of the smart contract. Transactions may include updates to the current values. Accordingly, when a transaction that affects the variables is validated and added in a block to the blockchain, the nodes can make any updates to the state database in accordance with the transaction. Such updates cause the state of the smart contract to change, and trigger events in accordance with the smart contract program code.

Furthermore, in the following, various embodiments are described with respect to methods and systems for utilizing verifiable credentials including embedded decentralized identifiers and decentralized identity management for authorizing access to confidential information maintained by a third party entity (e.g., acting as credentials for access and/or decryption of confidential information). In various embodiments, verifiable credentials including embedded decentralized identifiers allow individualized access control to documents stored by a third party. Verifiable credentials may include digital credentials that are cryptographically stored and/or secured to provide verifiable identification of an entity or individual. One example of verifiable credentials may be provided by the World Wide Web Consortium's (W3C) Verifiable Credentials Data Model.

The use of verifiable credentials includes three primary parties: an entity that issues the verifiable credential; an entity that receives/holds the verifiable credential, and an entity that verifies the verifiable credential as part of an interaction or transaction. Issuing entities may include, but are not limited to, an entity that maintains or generates confidential information associated with a client entity, such as a bank or other financial institution that maintains financial information regarding a company. The verifiable credential may be issued to an identifier associated with a receiving entity, such as a decentralized identifier, and may include access information such as authorized resources, period for access, etc. Verifiable credentials are digitally signed by the issuing entity, for example, using a private key. Subsequently, the authenticity of the verifiable credential may be verified by non-issuing entities, such as, for example, through the use of a public key associated with the issuing entity.

Decentralized identifiers include unique identifiers that are created and/or managed by an entity associated with the identifier, and are not associated with a centralized issuing authority. A single entity may have multiple decentralized identifiers associated therewith. When a verifiable credential is created (e.g., issued), the verifiable credential may be associated with (e.g., issued to) any decentralized identifier selected by the receiving entity. The decentralized identifier may be embedded within the verifiable credential.

The disclosed systems and methods enable controlled, decentralized sharing of confidential information across entities and/or individuals. As one non-limiting example, a first entity (e.g., first firm, first individual, etc.) (e.g., the content storage entity) may maintain and/or generate confidential information of a second entity (e.g., a second firm, second individual, etc.) (e.g., the upstream entity) and may want to allow access to such information without exposing the confidential information to security risks associated with centralized authorization schemes and eliminating the overhead associated with generating credentials for a centralized authorization scheme. The first entity may store the confidential information, for example in a centralized database and/or on a distributed ledger in encrypted form. The first entity may issue a first verifiable credential to the second entity that allows the second entity access to the confidential information. The verifiable credential includes and/or is associated with a decentralized identifier associated with the second entity. For example, the decentralized identifier may be embedded within the verifiable credential. The decentralized identifier may include any suitable decentralized identifier, such as a blockchain address, a randomly generated identifier, etc. When the second entity attempts to access the confidential information, the second entity presents the verifiable credential to the first entity, which verifies the validity of the credential. Upon successful verification, the first entity provides access to the confidential information to the second entity.

Subsequently, the second entity may want to share the confidential information with a third entity (e.g., a third firm, third individual, etc.) (e.g., the downstream entity). The second entity may generate a second, or child, verifiable credential that authorizes access to the confidential information based on the existence of the first verifiable credential (e.g., the second verifiable credential may securely contain and/or reference at least a portion of the first verifiable credential). The second verifiable credential allows the third entity to access the confidential information without needing specific authorization from the first entity. The second verifiable credential includes and/or is associated a decentralized identifier associated with the third entity, which may be embedded in the second verifiable credential. When the third entity attempts to access the confidential information, the third entity presents the second verifiable credential to the first entity, which verifies the validity of the second verifiable credential and, optionally, the validity of the first (e.g., parent) verifiable credential. Upon successful verification of the second verifiable credential (or both verifiable credentials), the first entity provides access to the confidential information to the third entity.

As described herein, the use of verifiable, decentralized credentials eliminates the need for a content management entity, e.g., a first entity, to manage access credentials for downstream access to content maintained by the entity. Utilizing the disclosed systems and methods, when a downstream entity wishes to allow access to confidential information maintained by a content storage entity, and for which the upstream entity is authorized to provide access, the upstream entity may generate a verifiable credential, e.g., a child verifiable credential, that allows access to the confidential information maintained by the content storage entity without the content storage entity having to generate any additional credentials. In addition, the upstream entity may revoke access to the confidential information for the downstream entity by invalidating the verifiable credential (e.g., based on an expiration of time, active invalidation, etc.) and without needing to notify the content storage entity of the revocation of access.

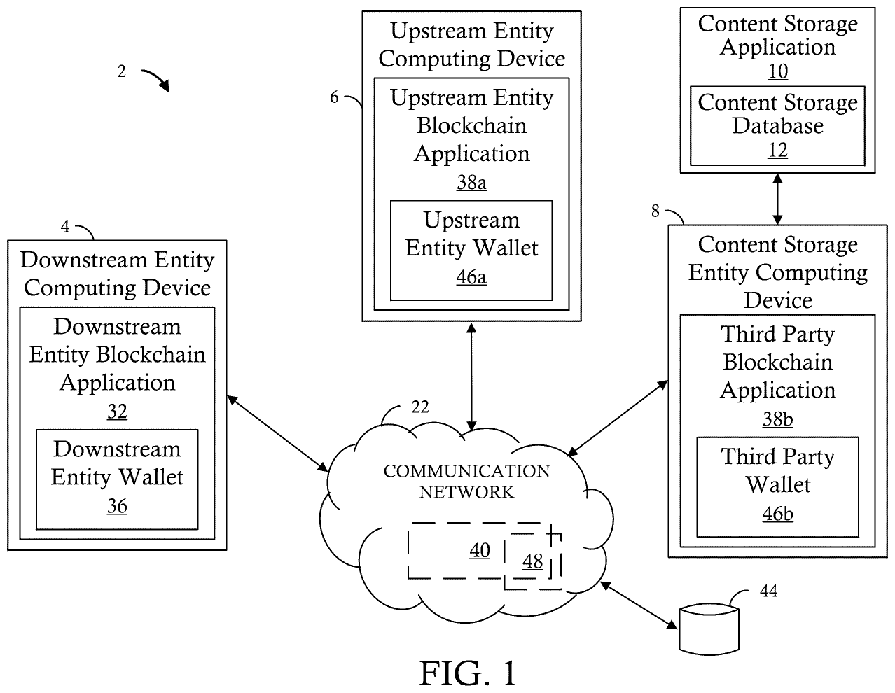

FIG. 1 illustrates a network environment 2 configured to provide verifiable, decentralized access to documents stored by a content storage entity, in accordance with some embodiments. The network environment 2 includes a plurality of devices or systems configured to communicate over one or more network channels, illustrated as a network cloud 22. For example, in various embodiments, the network environment 2 may include, but is not limited to, a downstream entity computing device 4, an upstream entity computing device 6, a content storage entity computing device 8, a third party application 10, and/or a public storage mechanism 44, each operatively coupled over the network 22. The downstream entity computing device 4, the upstream entity computing device 6, and/or the content storage entity computing device 8 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the downstream entity computing device 4, the upstream entity computing device 6, and/or the content storage entity computing device 8 may be a computer, a workstation, a laptop, a server such as a cloud-based server, or any other suitable device. In some embodiments, one or more of the downstream entity computing device 4, the upstream entity computing device 6, and/or the content storage entity computing device 8 may be a server that includes one or more processing units, such as one or more graphical processing units (GPUs), one or more central processing units (CPUs), and/or one or more processing cores. Each of the downstream entity computing device 4, the upstream entity computing device 6, and/or the content storage entity computing device 8, in some embodiments, execute one or more virtual machines. In some embodiments, processing resources (e.g., capabilities) of the downstream entity computing device 4, the upstream entity computing device 6, and/or the content storage entity computing device 8 are offered as a cloud-based service (e.g., cloud computing).

Although FIG. 1 illustrates three devices (e.g., downstream entity computing device 4, the upstream entity computing device 6, and the content storage entity computing device 8), the network environment 2 may include any number of computing devices and/or storage mechanisms. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the downstream entity computing device 4, the upstream entity computing device 6, and/or the content storage entity computing device 8 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the downstream entity computing device 4, the upstream entity computing device 6, and/or the content storage entity computing device 8 may communicate over the communication network 22. For example, each of the upstream entity computing device 4, the downstream entity computing device 6, and/or the content storage entity computing device 8 may be operable to view, access, and interact with a distributed ledger, e.g., a smart contract 30. Additionally, each of the downstream entity computing device 4 and/or the upstream entity computing device 6 may be operable to view, access, and/or interact with information (e.g., electronic data) maintained by the content storage entity computing device 8, such as in a database integrated with and/or in communication with the content storage entity computing device 8.

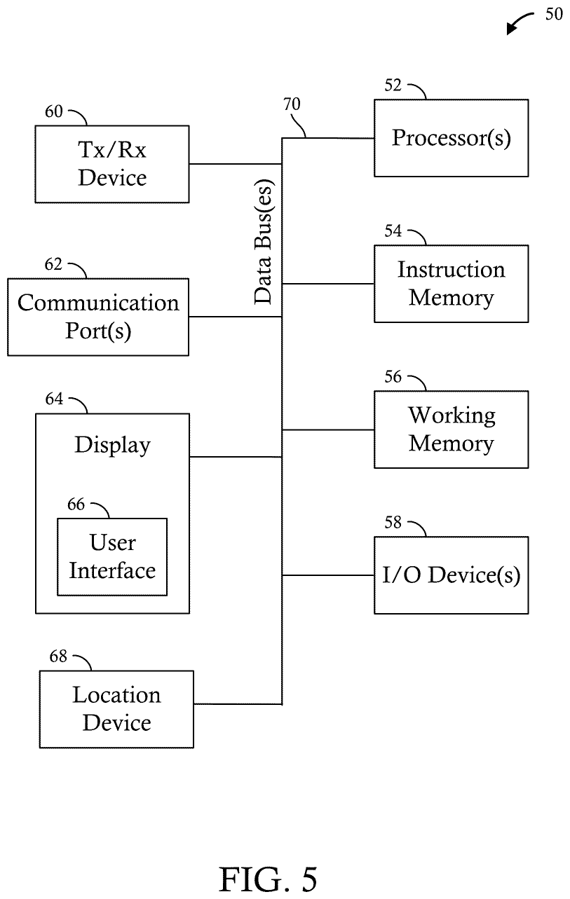

The upstream entity computing device 4 may implement a blockchain application 32, which may be stored as executable instructions in a corresponding memory (for example, as described in conjunction with FIG. 5). The blockchain application 32 enables the upstream entity computing device 4 to interact with a blockchain 40. For example, the blockchain application 32 may include application programing interfaces (APIs) that can query blockchain nodes, transmit data from the confirmation entity computing device 4 to blockchain nodes (e.g., to provide or submit a transaction to the blockchain), monitor the blockchain (e.g., by monitoring for events generated by a smart contract that contain the blockchain address of the upstream entity computing device 4), and otherwise exchange information with blockchain nodes and the upstream entity computing device 4. Accordingly, the blockchain application 32 may implement the functionality of a so-called “blockchain oracle.”

The blockchain application 32 may further enable the upstream entity computing device 4 to generate verifiable credentials associated with the blockchain 40. For example, when the upstream entity computing device 4 is initially associated with the blockchain 40 via the blockchain application 32, the blockchain 40 generates a distributed identifier 34 that is associated with the confirmation entity computing device 4 and stored in a storage mechanism, e.g., a blockchain wallet 36, maintained by the confirmation entity computing device 4. The distributed identifier 34 may have a private key associated therewith that enables secure transactions between the confirmation entity computing device 4 and the blockchain 40. The distributed identifier 34 may be utilized as a decentralized identifier associated with the upstream entity.

It is noted that although FIG. 1 illustrates the blockchain application 32 as a standalone application, the functionality of the blockchain application 32 can also be provided in the form of an online service accessible via a web browser executing on the confirmation entity computing device 4, as a plug-in or extension for another software application executing on the upstream entity computing device 4, etc. The blockchain application 32 may be a distributed application (DApp) with backend functions implemented by the blockchain nodes.

The downstream entity computing device 6 may include one or more processors and a memory, for example, as discussed in greater detail below with respect to FIG. 5. The downstream entity computing device 6 may similarly implement a blockchain application 38a that enables the corresponding downstream entity computing device 6 to interact with the blockchain 40, similar to the blockchain application 32. In some embodiments, the blockchain application 38a includes and/or is in communication with a respective blockchain wallet 46a.

The content storage entity computing device 8 also includes one or more processors and a memory, for example, as discussed in greater detail below with respect to FIG. 5. In addition, the content storage entity computing device 8 implements a blockchain application 38b that enables the content storage entity computing device 8 to interact with the blockchain 40 similar to the blockchain application 32. The content storage entity computing device 8 can be communicatively coupled to a content storage database 42 that stores data maintained by the content storage entity. The data stored in the content storage database 42 may include information relating to the one or more other entities, such as a target entity. For example, if the third party is a medical provider, the content storage database 42 may include patient information. If the third party is a company, the content storage database 42 may include customer records, accounting records, regulatory compliance records, etc. If the third party is a bank, the content storage database 42 may include customer account information, including information regarding a client that is subject to an audit. The content storage database 42 may utilize any known database architecture, and may include multiple databases.

Further, each of the downstream entity computing device 4, the upstream entity computing device 6, and/or the content storage entity computing device 8 may access a public storage system 44. The public storage system 44 may have a distributed architecture (e.g., multiple servers interconnected via a communication network, such as the network 22). For example, the public storage system 44 may function in accordance with the InterPlanetary File System (IPFS) protocol. The public storage system 44 is publicly accessible such that all interested parties (e.g., the downstream entity computing device 4, the upstream entity computing device 6, the content storage entity computing device 8, and/or other entities not depicted in FIG. 1) may access the public storage system 44 without private login information. Different locations within the public storage system 44 may be defined by unique addresses.

Each of the downstream entity computing device 4, the upstream entity computing device 6, and/or the content storage entity computing device 8 may be configured to access, via the network 22, the blockchain 40 maintained by a plurality of nodes. The downstream entity computing device 4, the upstream entity computing device 6, and/or the content storage entity computing device 8 may serve as one of the nodes that supports the blockchain 40. Further, other computing devices not shown in FIG. 1 can also make up the plurality of nodes.

In some implementations, the blockchain 40 may be a public blockchain, meaning that any party may view the shared ledger, submit new information to be added to the ledger, and/or join the network as a validating node. In other implementations, the blockchain 40 may be a private blockchain (e.g., a permissioned ledger) that keeps chain data private among a group of entities authorized to participate in the blockchain network (e.g., the downstream entity, the upstream entity, and the content storage entity). In still other implementations, the blockchain 40 may be both permissioned and permissionless whereby participants may need to be validated, but only the information that participants in the network wish to be public is made public.

While not shown in FIG. 1 to avoid clutter, each node may include at least one processor, a memory, a communication interface, an I/O interface, one or more applications, an OS, and a blockchain manager. Each node maintains a copy of the blockchain (i.e., the distributed ledger). As changes are made to the blockchain, each node receives the change (e.g., via the network 22) and updates its respective copy of the blockchain. The nodes may use a consensus mechanism to determine whether it is appropriate to make any received changes to the blockchain. Each node therefore has its own copy of the blockchain that is identical to every other copy of the blockchain stored by the other nodes. As a result, the decentralized blockchain network is more robust than a central authority database system, in which there is a single point of failure.

Each node may generate a new block of transactions, or may broadcast transactions to other network nodes using the blockchain manager. Similarly, the node may use the blockchain manager in connection with smart contracts stored in the memory of the node to execute the functionality disclosed herein. The memory of the node may further include chain data including, for example, a state database of the blockchain for storing states of smart contracts deployed thereon, such as a smart contract 48.

The smart contract 48 is deployed on the blockchain 40 and can be invoked by the components of the network environment 2 to implement the techniques of this disclosure. The nodes of the blockchain 40 can execute the code contained in the smart contract 48 and can each store a copy of the state database for the smart contract 48. In response to validating transactions submitted to the smart contract 48, the nodes can update the state of the smart contract 48, thereby triggering events in accordance with the terms of the smart contract 48.

In the embodiments discussed below, each of the downstream entity, the upstream entity, and the content storage entity are associated with (e.g., registered with) the blockchain 40. During registration, each of the entities are issued a public-private key pair that is associated with the corresponding entity and stored in a corresponding wallet, as discussed above. Each wallet may be maintained by a corresponding device. For example, a public-private key pair may be issued to and associated with the confirmation entity and maintained by a wallet 36 stored on a downstream entity computing device 4. Similarly, public-private key pairs may be issued to and associated with each of the target entity and the third party entity and stored in wallets 46a, 46b maintained by corresponding devices, e.g., an upstream entity computing device 6 and a content storage entity computing device 8. In addition, in some embodiments, a decentralized identifier may be generated and associated with the corresponding entity during and/or after registration with the blockchain 40.

In some embodiments, the network environment 2 is configured to allow one or more computing devices to interact with the blockchain 40, in accordance with some embodiments. The downstream entity computing device 4 is coupled to a confirmation entity wallet 36. The downstream entity wallet 36 is an electronic wallet that stores cryptographic keys associated with a confirmation entity. In particular, the downstream entity wallet 36 may store pairs of public and private cryptographic keys that are used for encryption and decryption. The downstream entity wallet 36 can be software included within the downstream entity computing device 4 or accessible from the downstream entity computing device 4. In some implementations, the downstream entity wallet 36 is a hardware wallet that can be coupled to the downstream entity computing device 4. Likewise, the upstream entity computing device 6 and/or the content storage entity computing device 8 may each be coupled to a corresponding entity wallet 46a-46b.

The upstream entity computing device 4 can interact with the blockchain 40 by implementing the blockchain application 32. For example, the blockchain application 32 can broadcast transactions to the smart contract 48 deployed on the blockchain 40. The blockchain application 32 can digitally sign transactions using a private key associated with the confirmation entity and stored in the confirmation entity wallet 36. Other nodes and/or entities can verify that the source of the transaction is the confirmation entity by attempting to decrypt the digital signature using a public key associated with the confirmation entity. If another node is unable to decrypt the digital signature, the node can detect the transaction request as a spoofing attempt. Otherwise, the node can detect that the transaction request indeed originated from the indicated source, e.g., the confirmation entity.

The blockchain application 32 can also encrypt data that is stored or broadcast to the blockchain using a public key of a particular entity. Only an entity with access to the particular entity's private key (i.e., only the particular entity, provided the particular entity's private key is secure) will be able to decrypt the data. Accordingly, the blockchain application 32 can also use a private key of the confirmation entity to decrypt data that was encrypted using a public key of the confirmation entity.

To identify a public key of an entity, the nodes of the blockchain 40 and the other components of the computing environment 2 can access a blockchain name service, which is a directory or database that stores public keys. Additionally, the blockchain application 32 can monitor the blockchain 40 to detect events generated by the smart contract 48 (e.g., in response to an update to the state of the smart contract 48). The components of the computing environment 2 (e.g., blockchain applications 32, 38a, 38b), the nodes of the blockchain 40, the smart contract 48, etc.) are each associated with a blockchain address. The blockchain application 32 can direct transactions to the smart contract 48 by identifying the smart contract 48 using the smart contract address, and can similarly include the blockchain addresses of a target entity blockchain application 38a and/or a third party blockchain application 38b in the transactions. Further, the blockchain application 32 can detect when the smart contract 48 generates an event containing the blockchain address of the blockchain application 32.

The blockchain applications 38a, 38b associated with the upstream entity computing device 6 and/or the content storage entity computing device 8 may implement analogous functionality to the blockchain application 32. Additionally, the content storage entity computing device 8 may be communicatively coupled to an off-blockchain device (not shown). The off-blockchain device may be associated with one or more entities (e.g., the target entity) and may be similar to the devices 4-8 discussed above. However, the off-blockchain device does not interact directly with the blockchain 40. The off-blockchain device may implement a content storage application associated with the content storage entity. For example, if the content storage entity is a company, the content storage application may be an application that enables customers to manage their accounts with the company. If the content storage entity is a bank, the content storage application may be an online banking platform or other application that allows the device to access accounts of the upstream entity that are managed by the bank. If the content storage entity is a medical provider, the content storage application may be an e-health platform that allows the patient (e.g., downstream entity) to securely view and manage their health records.

In some embodiments, access to the information maintained by the content storage entity may be granted via verifiable credentials. When an upstream entity first becomes associated with a content storage entity, a verifiable credential is issued that allows access to information maintained by the content storage entity associated with and/or owned by the upstream entity. For example, where the content storage entity is a company, a verifiable credential may be issued to a customer when the customer registers with an application that enables the customer to manage their accounts with the company. As another example, where the content storage entity is a bank, a verifiable credential may be issued to an account holder when an account is generated and/or configured for online access. As another example, where the content storage entity is a medical provider, a verifiable credential may be issued to a patient when the patient first becomes a patient of the medical provider and/or when the patient request online access to their medical records. The upstream entity may utilize a computing device, such as an upstream entity computing device 6, to access information maintained by the content storage entity computing device 8 by providing a verifiable credential and/or a token including an embedded verifiable credential to the content storage entity computing device 8, which verifies the verifiable credential and provides access to the stored information.

In some instances, a downstream entity may wish to provide access to certain information maintained by the content storage entity to an additional entity or party (e.g., a downstream entity), for example, when an upstream entity and a downstream entity are associated for an interaction between the upstream entity and the downstream entity requiring confirmation of certain information related to the upstream entity by the downstream entity. In order to authorize access to the corresponding information, the upstream entity may issue a verifiable credential for a decentralized identifier associated with the downstream entity and/or may provide an authorization token 90 including an embedded verifiable credential to the downstream entity. In some embodiments, an authorization token 90 includes an embedded verifiable credential including a decentralized identifier that is associated with the downstream entity and a set of access conditions (e.g., resources to be accessed, time period for access, etc.). The verifiable credential and/or the authorization token 90 are signed (e.g., includes and/or is otherwise encoded by) a private key associated with the upstream entity and is issued for the decentralized identifier associated with the downstream entity. For example, the authorization token 90 may be encrypted and/or generated using a public key associated with the downstream entity such that the authorization token 90 may only be decrypted and used by the downstream entity via the private key associated with the downstream entity. As discussed in greater detail below, when the downstream entity seeks to access data associated with the upstream entity and maintained by a content storage entity, the downstream entity may provide the authorization token 90 to authenticate authorization by the downstream entity to access to data maintained by the content storage entity (e.g., as part of an authentication process).

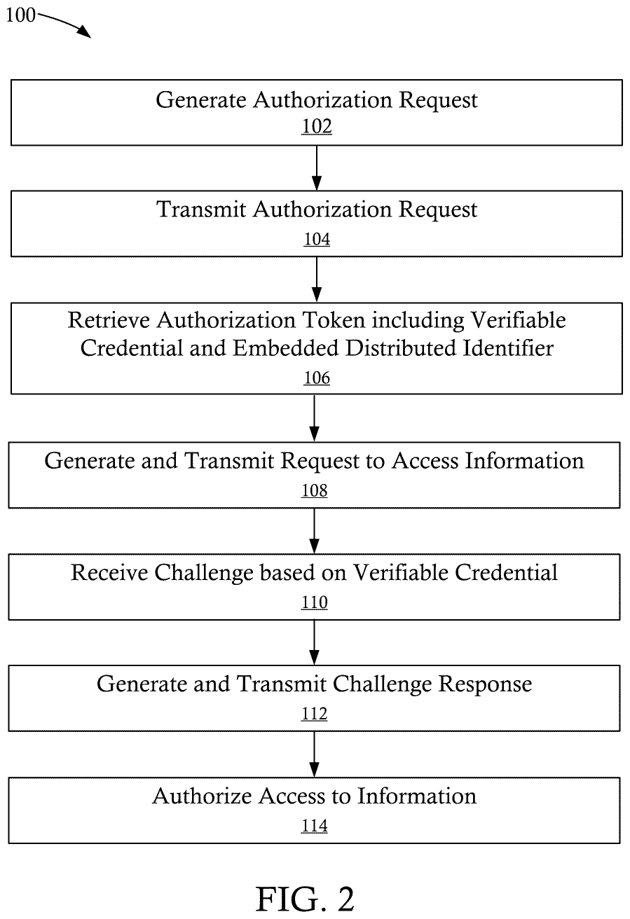

FIG. 2 is a flowchart illustrating a method 100 of providing authorization to and retrieval of upstream entity information via a blockchain using verifiable credentials including embedded decentralized identifiers, in accordance with some embodiments. At step 102, an authorization request for access to information pertaining to an upstream entity is generated. The authorization request may include a blockchain address of the upstream entity. The authorization request may be generated by a downstream entity, such as an auditing entity, to confirm information provided by and/or associated with the upstream entity.

At step 104, the authorization request is transmitted, for example, to a distributed ledger such as a smart contract 48 deployed on a blockchain 40, directly to an upstream entity computing device 6, and/or via any other transmission process. The authorization request may be transmitted by a blockchain application 32 in accordance with one or more requirements established by the distributed ledger, e.g., established by the smart contract 48. At step 106, a response to the authorization request including an authorization token is received. The authorization response may be received via the distributed ledger and/or directly from an upstream entity computing device 6. For example, in some embodiments, the authorization response is generated by the upstream entity blockchain application 38a executed by the target entity computing device 6. Although embodiments are discussed herein including an authorization response transmitted via a blockchain 40, it will be appreciated that an authorization transaction may be transmitted directly from the upstream entity computing device 6 to the downstream entity computing device 6 without use of the blockchain.

The downstream entity computing device 4 retrieves (e.g., obtains, receives, etc.) a verifiable credential and/or an authorization token including an embedded verifiable credential based on at least a portion of the authorization response. The verifiable credential is generated and transmitted by the upstream entity computing device 6, for example, based on a verifiable credential maintained by and/or issued to the upstream entity. The authorization token may be retrieved from any suitable repository, such as, for example, a network storage 44, and/or transmitted directly to the downstream entity computing device 4. The verifiable credential and/or the authorization token may be received in an encrypted and/or decrypted form. As discussed herein, the verifiable credential and/or the authorization token may be issued and/or signed via a private key associated with the upstream entity and is configured to allow access to information associated with the upstream entity and maintained by the content storage entity.

At step 108, a request to access information pertaining to an upstream entity and maintained by the content storage entity is generated and transmitted to the content storage entity. In some embodiments, the request may be transmitted via a blockchain request including a blockchain address of a content storage entity to which the request is directed and the authorization token. The request may be generated by a blockchain application 32 implemented by a confirmation entity computing device 4. In some embodiments, the request may be transmitted directly from the downstream entity computing device 4 to the content storage entity computing device 8. The request may identify one or more data repositories to be accessed via the content storage entity and may include the authorization token. The content storage entity may utilize the authorization token to authenticate access to the desired information.

For example, in some embodiments, the authorization token includes a downstream verifiable credential having an embedded decentralized identifier and, optionally, a set of access conditions defining access to information maintained by the content storage entity. As discussed in greater detail below, the content storage entity computing device 8 may receive the authorization token and verify the downstream verifiable credential via one or more challenges. The downstream verifiable credential may include and/or reference an upstream verifiable credential of the upstream entity. The content storage entity computing device 8 may verify both the downstream verifiable credential and the upstream verifiable credential as part of a verification process. When the downstream verifiable credential is verified, the request may be processed.

At step 110, a verification challenge is issued and/or initiated by the content storage entity computing device 8 to verify that the requesting entity (e.g., the downstream computing device 4) is the entity associated with the downstream verifiable credential embedded within the authorization token. The verification challenge may request generation of a response containing data that may be read/generated only by the entity associated with the downstream verifiable credential. For example, in some embodiments, a verification challenge may require decryption of data encrypted using a public key associated with the downstream entity that may only be decrypted through use of a corresponding private key controlled by the downstream entity. Although specific verification challenges are discussed herein, it will be appreciated that any suitable verification challenge may be used to confirm the identity of the computing system providing the verifiable credential as the owner of the verifiable credential.

At step 112, a challenge response is transmitted, for example, via the smart contract. The challenge response includes a response to the verification challenge received at step 110. For example, in some embodiments, the downstream entity computing device 4 is configured to transmit a response encrypted with a private key associated with the downstream entity that may only be decrypted using a public key associated with the downstream entity and/or data allowing access to the requested resource (e.g., corresponding portions of a storage mechanism maintained by the content storage entity). As another example, the challenge response may include at least a portion of previously encrypted/transmitted data and/or a response to a data generation request, allowing the content storage entity computing device 8 to verify that the downstream entity computing device 4 is associated with the downstream entity corresponding to the verifiable credential and/or decentralized identifier.

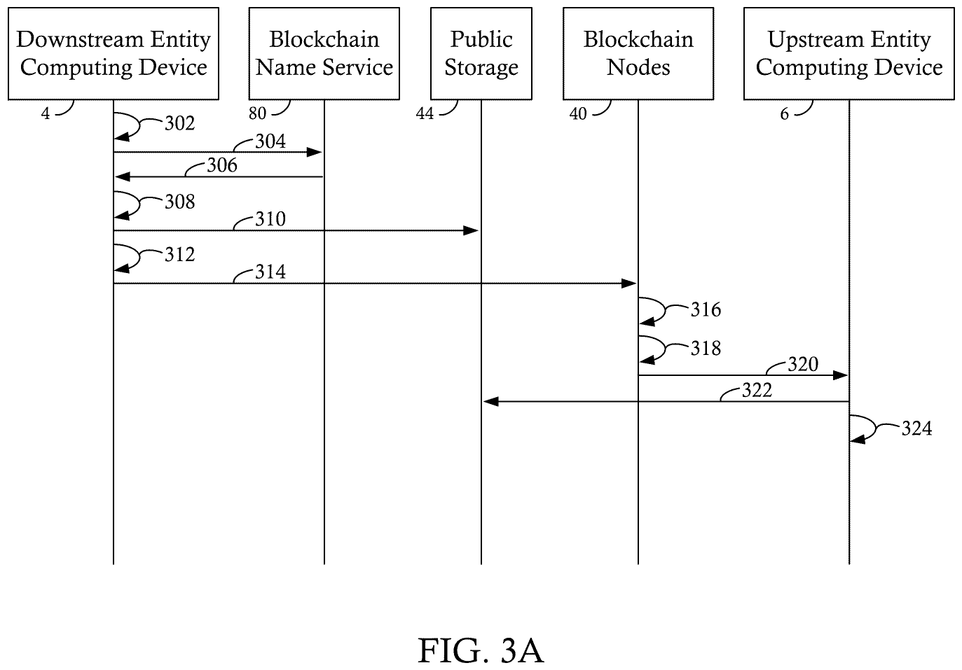

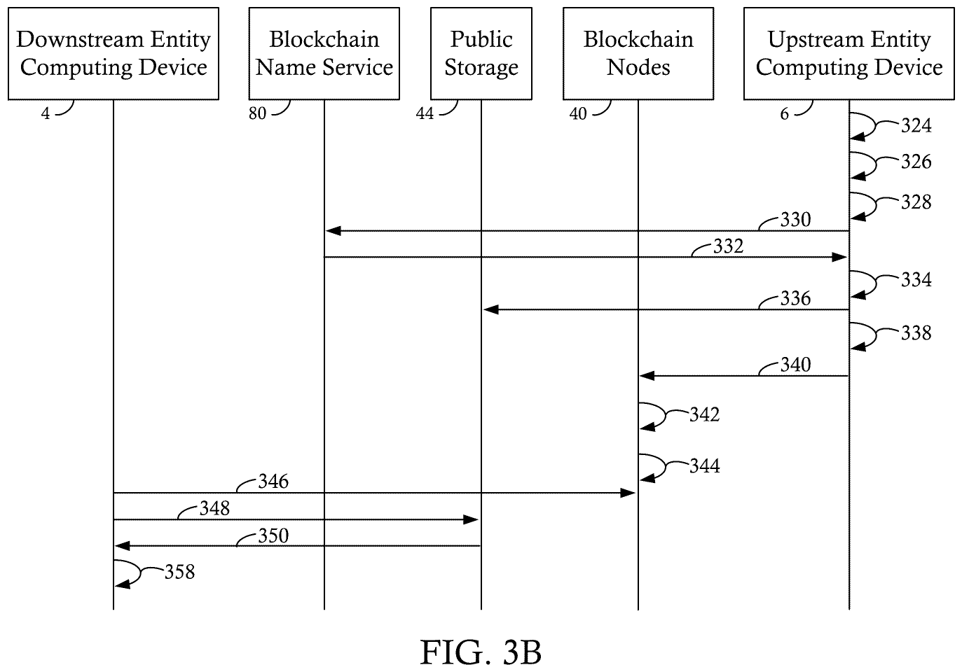

FIGS. 3A-3B illustrate an example scenario 300 for generating an authorization token including a verifiable credential having a decentralized identifier embedded therein. FIG. 3A illustrates generation of an initial request for authorization. Initially, a downstream entity computing device 4 prepares 302 a request for authorization for information maintained by a content storage entity. The request may include a cryptographically generated request, such as a request submitted to a blockchain 40 via a blockchain application 32. In other embodiments, the request is transmitted directly to the upstream entity computing device 6.

In some embodiments, a user, such as an auditor, associated with the downstream entity can utilize the downstream entity computing device 4 to prepare the request for authorization and submit the request to the blockchain application 32 and/or the upstream entity computing device 6. In some implementations, the user prepares the request for authorization using the blockchain application 32. In other implementations, the user prepares the request for authorization using a different application that submits the prepared request for authorization to the blockchain application 32 and/or the upstream entity computing device 6 for processing. In yet other implementations, the blockchain application 32 (or another application associated with the confirmation entity) may automatically generate the request for authorization in accordance with an ongoing audit. The blockchain application 32 may need to format the prepared request for authorization prior to sharing or storing the request.

The request for authorization identifies an upstream entity, such as that the downstream entity seeks to investigate. The request may take different forms depending on the implementation. In some implementations, the request indicates the reason for the investigation and/or the interaction associated with the investigation. For example, the request for authorization may request authorization for a single interaction and/or an ongoing relationship.

In some embodiments, the request for authorization includes a decentralized identifier associated with the downstream entity. For example, the request for authorization may include a blockchain address and/or other randomly generated identifier associated with the upstream entity. As another example, the request for authorization may include a decentralized identifier selected by the upstream entity and incorporated into the request. It will be appreciated that any suitable decentralized identifier may be included with and/or associated with the request for authorization. The decentralized identifier may be generated according to any suitable process and/or guidelines, such as, for example, W3C recommendations on Decentralized Identifiers (DIDs).

For embodiments where the request is submitted via a blockchain 40, the blockchain application 32 identifies the upstream entity, for example, based on the information in the request. The blockchain application 32 requests 304 a blockchain address and public key of a blockchain application 38a associated with the upstream entity from the blockchain name service 80 and receives 306 the blockchain address and public key from the blockchain name service 80 in response. If the blockchain application 32 is already aware of the blockchain address or the public key, then the blockchain application 32 can omit steps 304-306. Similarly, where the request for authorization is submitted directly to the upstream entity computing device 6, steps 304-306 are omitted.

The request for authorization may be encrypted 308 using a cryptographic algorithm. In some implementations, the request for authorization is encrypted using a symmetric key, which may be randomly generated using a random number generator (RNG) or other suitable cryptographic key generator. In other implementations, the request for authorization is encrypted using a public key of the target entity, e.g., a public key associated with a blockchain application 38a. The blockchain application 32 may also calculate a hash of the encrypted request.

In some implementations, the downstream entity computing device 4 can then store 310 the encrypted request in the public storage system 44 accessible by the upstream entity computing system 6. In other implementations, the downstream entity computing device 4 refrains from storing the encrypted request in the public storage system 44, and may instead transmit the encrypted request directly to the upstream entity computing device 6 and/or include the encrypted request in a request transaction that the downstream entity computing device 4 generates at event 312 (introduced below).

Next, the downstream entity computing device 4 generates 312 a request transaction (i.e., a transaction to submit to the blockchain 40 associated with the request). The request transaction includes an indication of a location of the encrypted request (e.g., a location of the encrypted request stored in the public storage system 44). The request transaction may also include the hash of the encrypted request. Additionally or alternatively, the downstream entity computing device 4 may include the encrypted request in the request transaction (e.g., in implementations where the downstream entity computing device 4 does not store 310 the encrypted request in the public storage system 44). Further, the request transaction may include the blockchain address of the upstream entity blockchain application 38a. In addition, the request transaction may include a mechanism by which to decrypt the encrypted request. For example, if the downstream entity computing device 4 encrypted the request using a symmetric key, the downstream entity computing device 4 may encrypt the symmetric key using the public key of the upstream entity and include the encrypted symmetric key in the transaction request.

In some embodiments, the downstream entity computing device 4 also signs the request transaction with a private key associated with the downstream entity. The downstream entity computing device 4 may automatically sign the request transaction, or may prompt a user of the downstream entity computing device 4 to sign the request. In some embodiments, the private key utilized for signing the request is associated with the decentralized identifier incorporated intro and/or associated with the request.

Next, the downstream entity computing device 4 submits 314 the request transaction to the blockchain 40. To submit 314 the request, the confirmation entity blockchain application 32 may send the request transaction to the blockchain address of one or more nodes. The nodes of the blockchain 40 independently process the request transaction to validate 316 the request transaction. Validating the request transaction may include determining that the request transaction satisfies the consensus rules of the blockchain 40. For example, validating the request transaction may include determining that the request transaction originated from an authorized source. If the nodes validate 316 the request transaction, the request transaction is included in a block that is added to the blockchain 40.

In response to validating 316 the request transaction, an event is generated 318 (e.g., by a smart contract 48) including the blockchain address of the upstream entity blockchain application 38a. This can also be referred to as “emitting” an event. The event notifies the upstream entity blockchain application 38a of the existence of the new request transaction addressed to the upstream entity. Accordingly, the upstream entity blockchain application 38a detects 320 the event and retrieves the request transaction from the blockchain 40. In some embodiments, steps 314-320 are omitted and the request transaction is transmitted directly to the upstream entity computing device 6.

The upstream entity computing device 6 uses the information in the request transaction to retrieve 322 the encrypted request. In particular, the upstream entity computing device 6 can determine the location of the encrypted request based on the request transaction (e.g., the location in the public storage system 44, if the encrypted request is not included in the request transaction). If the request transaction includes the symmetric key encrypted by a public key, e.g., the public key associated with the upstream entity, the upstream entity computing device 6 decrypts the symmetric key using a corresponding private key, e.g., the private key associated with the upstream entity. Further, the upstream entity computing device 6 can calculate a hash of the stored encrypted request and compare the calculated hash to a hash included in the request transaction to verify that the stored encrypted request has not been altered.

The upstream entity computing device 6 then decrypts 324 the encrypted request for authorization. In some embodiments, the upstream entity computing device 6 decrypts 324 the encrypted request for authorization using the symmetric key. In other embodiments, the upstream entity computing device 6 can decrypt 324 the encrypted request for authorization using a private key.

FIG. 3B illustrates a continuation of the example scenario 300 that occurs after receipt and decryption of the authorization request by the upstream entity computing device 6. The upstream entity computing device 6 can verify 326 the originator of the request transaction. After retrieving the public key of the downstream entity (e.g., from the blockchain name service 80), the upstream entity computing device 6 can decrypt the signature included in the request transaction to validate that the request transaction was signed with the private key associated with the downstream entity and/or the decentralized identifier included in the authorization request.

After decrypting 324 and optionally verifying 326 the request for authorization, the upstream entity computing device 6 can generate 328 an authorization token for use by the downstream entity computing device 4. As illustrated in FIG. 3B, the upstream entity computing device 6 generates 328 a signed authorization token. The authorization token may be generated using any suitable process. For example, in the illustrated embodiment, the upstream entity computing device 6 may generate an authorization token using a cryptographic generation process defined by the blockchain 40 including signing of a generated authorization token with a private key associated with the target entity.

In some embodiments, the authorization token includes a verifiable credential issued by the upstream entity computing device 6 for the downstream entity and/or the decentralized identifier associated with the downstream entity. The verifiable credential may include any suitable verifiable credential and may include an upstream verifiable credential (or a portion thereof) issued to the upstream entity by a third party, such as the content storage entity. The verifiable credential may be generated according to any suitable process, such as, for example, the W3C Verifiable Credentials Data Model v1.1.

In some embodiments the authorization token and/or the verifiable credential embedded within the authorization token includes the decentralized identifier associated with the downstream entity and incorporated into the authorization request. The decentralized identifier may be provided in an unencrypted form, an encrypted form, and/or otherwise referenced by an identifier (e.g., a reference to a blockchain address being used as a decentralized identifier). In some embodiments, the inclusion of a decentralized identifier ties the issue verifiable credential to the decentralized identifier.

Next, the upstream entity computing device 6 identifies the downstream entity, for example, based on the information in the request for authorization, such as the decentralized identifier. The upstream entity computing device 6 may request 330 a blockchain address and public key associated with the downstream entity from the blockchain name service 80 and may receive 332 the blockchain address and public key from the blockchain name service 80 in response. If the upstream entity computing device 6 is already aware of the blockchain address or the public key, for example if such information was included in the request for authorization, then the target entity blockchain application 38a can omit the steps 330-332. Similarly, if the upstream entity computing device 6 transmits the authorization token directly to the downstream entity computing device 4, steps 330-332 may be omitted.

In some embodiments, the upstream entity computing device 6 encrypts 334 the authorization token using a cryptographic algorithm. In some implementations, the upstream entity computing device 6 encrypts the authorization token using a public key of the downstream entity, e.g., a public key associated with a downstream blockchain application 32. The upstream entity computing device 6 may also calculate a hash of the authorization token.

In some implementations, the upstream entity computing device 6 can then store 336 the authorization token in the public storage system 44 accessible by the downstream entity computing device 4. In other implementations, the upstream entity computing device 6 refrains from storing the encrypted authorization token in the public storage system 44, and may instead include the encrypted authorization token in an authorization notification that the upstream entity computing device 6 generates at event 338 (introduced below) and/or may transmit the authorization token directly to the downstream entity computing device 4.

Next, the upstream entity computing device 6 may generate 338 an authorization token generation notification (e.g., an authorization response). The authorization token generation notification includes an indication of a location of the encrypted authorization token (e.g., a location of the encrypted authorization token stored in the public storage system 44). The authorization token generation notification may also include the hash of the encrypted authorization token. Additionally or alternatively, the upstream entity computing device 6 may include the encrypted authorization token in the authorization token generation notification (e.g., in implementations where the upstream entity computing device 6 does not store the encrypted authorization token generation notification in the public storage system 44). Further, the authorization token generation notification may include the blockchain address of the downstream entity blockchain application 32. In addition, the authorization token generation notification may include a mechanism by which to decrypt the encrypted authorization token. For example, if the upstream entity computing device 6 encrypted the authorization token 90 using a symmetric key, the upstream entity computing device 6 may encrypt the symmetric key using the public key of the downstream entity and include the encrypted symmetric key in the authorization token generation notification.

The upstream entity computing device 6 may sign the authorization token generation notification with a private key associated with the upstream entity. The upstream entity computing device 6 may automatically sign the authorization token generation notification or may prompt a user of the upstream entity computing device 6 to sign the authorization token generation notification.

The upstream entity computing device 6 may submit 340 the authorization token generation notification to the blockchain 40. To submit 340 the authorization token generation notification, the upstream entity computing device 6 may send the authorization token generation notification to the blockchain address of one or more nodes. The nodes of the blockchain 40 independently process the authorization token generation notification to validate 342 the authorization token generation notification. If the nodes validate 342 the authorization token generation notification, the authorization token generation notification is included in a block that is added to the blockchain 40.

In response to validating 342 the authorization token generation notification, an event is generated 344 (e.g., by a smart contract 48) including the blockchain address of the downstream entity blockchain application 32. The event notifies the downstream entity blockchain application 32 of the existence of the new authorization token generation notification addressed to the confirmation entity. Accordingly, the downstream entity blockchain application 32 detects 346 the event and retrieves the authorization token generation notification from the blockchain 40.

In some embodiments, the downstream entity computing device 4 uses the information in the authorization token generation notification to request 348 and/or retrieve 350 the encrypted authorization token. In particular, the downstream entity computing device 4 can determine the location of the encrypted authorization token based on the authorization token generation notification (e.g., the location in the public storage system 44, if the encrypted authorization token is not included in the authorization token generation notification). If the authorization token generation notification includes the symmetric key encrypted by a public key, e.g., the public key associated with the downstream entity, the downstream entity computing device 4 decrypts the symmetric key using a corresponding private key, e.g., the private key associated with the downstream entity. Further, the downstream entity computing device 4 can calculate a hash of the stored encrypted authorization token and compare the calculated hash to a hash included in the authorization token generation notification to verify that the stored encrypted authorization token has not been altered. In some embodiments, the authorization token may be transmitted directly to the downstream entity computing device 4 such that steps 336-350 may be omitted and/or substituted with alternative steps for transmitting the authorization token directly to the downstream entity computing device 4.

The downstream entity computing device 4 may decrypt 352 and utilize the decrypted authorization token to perform additional operations, such as obtaining access to information from a content storage entity, as discussed in greater detail below. Although embodiments are discussed herein including generation and issuance of an authorization token, it will be appreciated that, in some embodiments, a pre-generated authorization token associated with the downstream entity may be updated and/or amended to include the verifiable credential and/or a decentralized identifier to enable authorization to access information of the upstream entity according to a process similar to that discussed above. In such embodiments, instead of issuing an authorization token, the upstream entity computing device 6 may generate a blockchain transaction to update and/or modify the authorization token associated with the downstream entity to include a verifiable credential issued by the upstream entity.

The authorization token may include additional data identifying the confidential information authorized for access by the downstream entity. For example, in some embodiments, the authorization token may identify specific repositories, specific files, specific data types, specific data elements, etc. maintained by a content storage entity that are authorized for sharing with the downstream entity. As another example, in some embodiments, the authorization token may be issued for a specific document to enable retrieval and decryption of the corresponding document. It will be appreciated that any suitable form of access may be authorized by an authorization token.

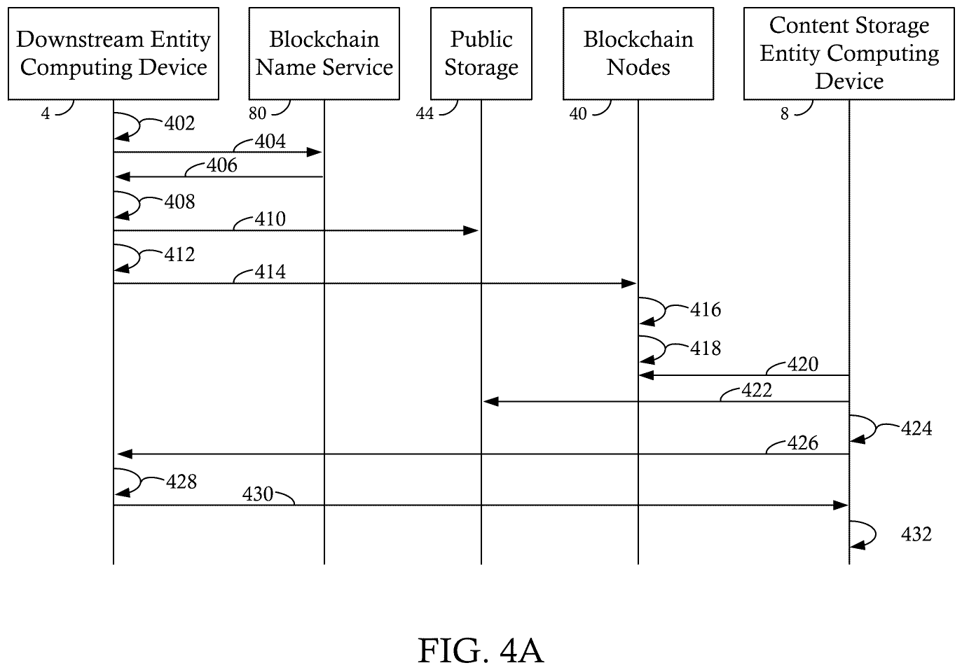

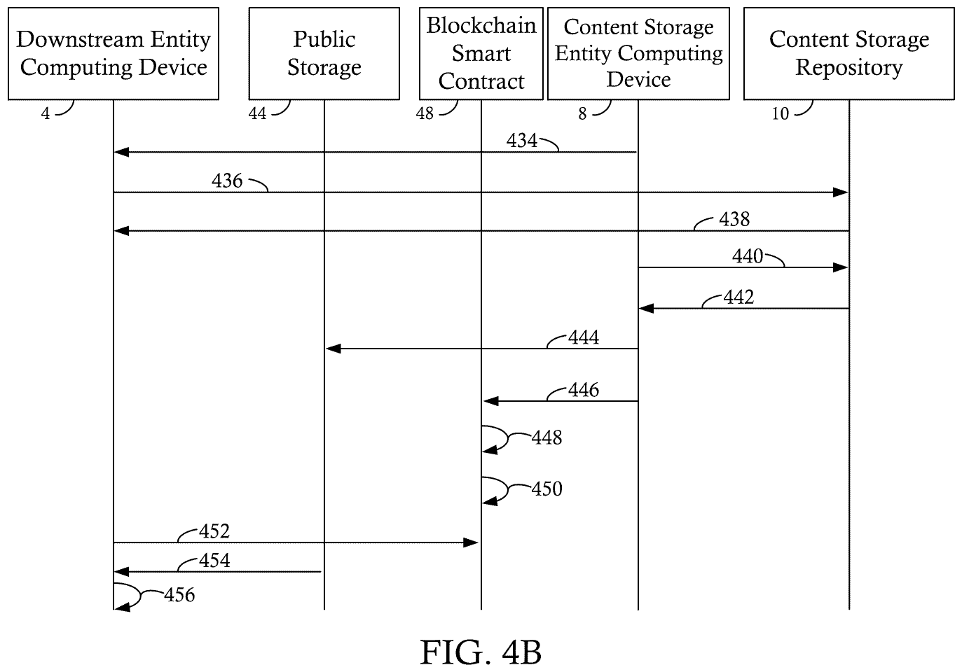

In various embodiments, a downstream entity may utilize an issued authorization token, including a verifiable credential with an integrated decentralized identifier, to access confidential information of and/or about the upstream entity that is maintained by a content storage entity. FIGS. 4A-4B illustrate an example scenario 400 for processing a request for access involving a content storage entity. Initially, the downstream entity computing device 4 receives 402 a prepared request. A user, such as an auditor, associated with an entity, such as the downstream entity, can utilize the downstream entity computing device 4 to prepare the request and submit the request. In some implementations, the user prepares the request using the downstream entity blockchain application 32. In other implementations, the user prepares the request using a different application that submits the prepared request to the downstream entity blockchain application 32 and/or any other suitable application for processing. In yet other implementations, the downstream entity blockchain application 32 (or another application associated with the downstream entity) may automatically generate the request in accordance with an ongoing audit. The downstream entity computing device 4 may need to format the prepared request prior to sharing or storing the request. For example, if the prepared request includes confidential information that is not in a hashed format, the downstream entity computing device 4 can calculate a hash of the confidential information and include only the hash in the request. While this disclosure primarily refers to examples hashes of confidential information, as discussed above, in some implementations, the entities may calculate, exchange, and compare tokens rather than hashes.

The request identifies the upstream entity associated with the information maintained by the content storage entity. Additionally, the request identifies the content storage entity that stores the information regarding the upstream entity. For instance, the content storage entity may be an entity that maintains information of the upstream entity. The request may take different forms depending on the implementation. In some implementations, the request indicates a request to access information of the upstream entity stored by the content storage entity. For example, the information may be a statement or a record of the upstream entity. The request may indicate that any confidential information should be provided in a hashed format. As will be discussed in further detail below, the content storage entity computing device 8 can authorize access to information related to the request.

Next, the downstream entity computing device 4 identifies the content storage entity based on the information in the request. In some embodiments, the downstream entity computing device 4 requests 404 a blockchain address and public key of the third party blockchain application 38b from the blockchain name service 80 and receives 406 the blockchain address and public key from the blockchain name service 80 in response. If the downstream entity computing device 4 is already aware of the blockchain address or the public key, or if the request for information is transmitted directly to the content storage entity computing device 8, then the downstream entity computing device 4 can omit the steps 404-406.

The downstream entity computing device 4 encrypts 408 the request using a cryptographic algorithm. In some implementations, the downstream entity computing device 4 encrypts the request using a symmetric key, which the downstream entity computing device 4 may randomly generate using a random number generator (RNG) or other suitable cryptographic key generator. In other implementations, the downstream entity computing device 4 encrypts the request using a public key associated with the content storage entity. The downstream entity computing device 4 may also calculate a hash of the encrypted request.

In some embodiments, the downstream entity computing device 4 includes the authorization token and/or data contained within the authorization token (e.g. a verifiable credential, an integrated decentralized identifier, etc.) within the request for access. The authorization token may be independently encrypted and/or encrypted in conjunction with the request for information. In some implementations, the downstream entity computing device 4 encrypts the authorization token using a second symmetric key, which the downstream entity computing device 4 may randomly generate using a random number generator (RNG) or other suitable cryptographic key generator. In other implementations, the downstream entity computing device 4 encrypts the authorization token using a public key associated with the content storage entity computing device 8. The downstream entity computing device 4 may also calculate and include a hash of the encrypted authorization token.

In some implementations, the downstream entity computing device 4 can then store 410 the encrypted request for information, including the authorization token, in the public storage system 44 accessible by the content storage entity computing device 8. In other implementations, the downstream entity computing device 4 refrains from storing the encrypted request for access in the public storage system 44, and can instead include the encrypted request for access in the request transaction that the downstream entity computing device 4 generates at event 412 (introduced below). Alternatively, in some embodiments, the downstream entity computing device 4 may transmit the request for access directly to the content storage entity computing device 8.

Next, the downstream entity computing device 4 generates 412 a request transaction. The request transaction includes a request to access specific information and/or repositories maintained by the content storage entity. The request transaction may also include the hash of the encrypted request for access and/or the hash of the encrypted authorization token. Additionally or alternatively, the downstream entity computing device 4 may include the encrypted request for access and/or the encrypted authorization token in the request transaction (e.g., in implementations where the downstream entity computing device 4 does not store 410 the encrypted request for information in the public storage system 44). Further, the request transaction may include the blockchain address of the content storage entity blockchain application 38b. In addition, the request transaction may include a mechanism by which to decrypt the encrypted request. For example, if the downstream entity computing device 4 encrypted the request using a symmetric key, the downstream entity computing device 4 may encrypt the symmetric key using the public key associated with the content storage entity and include the encrypted symmetric key in the transaction request.

The downstream entity computing device 4 may also sign the request transaction with a private key associated with the downstream entity. The downstream entity computing device 4 may automatically sign the request transaction, or may prompt a user of the downstream entity computing device 4 to sign the request.

Next, the downstream entity computing device 4 submits 414 the request transaction to the smart contract 48 deployed on the blockchain 40. In some implementations, the downstream entity computing device 4 generates and deploys the smart contract to the blockchain, either before or upon generating the request transaction. In such implementations, each confirmation process may be associated with its own smart contract. In other implementations, another application may generate and deploy the smart contract. To submit 414 the request, the downstream entity computing device 4 may send the request transaction to the blockchain address of the smart contract 48. The nodes of the blockchain 40 independently process the request transaction using the executable program in the smart contract 48 to validate 416 the request transaction. Validating the request transaction may include determining that the request transaction satisfies the consensus rules of the blockchain 40. For example, validating the request transaction may include determining that the request transaction originated from an authorized source. If the nodes validate 416 the request transaction, the request transaction is included in a block that is added to the blockchain 40. Inclusion of the request transaction in the blockchain 40 causes an update to the state of the smart contract 48, which triggers a response in accordance with the terms of the smart contract 48.

In response to validating 416 the request transaction, the smart contract 48 generates 418 an event including the blockchain address of the content storage blockchain application 38b. The event notifies the content storage blockchain application 38b of the existence of the new request transaction addressed to the content storage blockchain application 38b. Accordingly, the content storage blockchain application 38b detects 420 the event and retrieves the request transaction from the blockchain 40.

The content storage blockchain application 38b uses the information in the request transaction to retrieve 422 the encrypted request for information. In particular, the content storage blockchain application 38b can determine the location of the encrypted request based on the request transaction (e.g., the location in the public storage system 44, if the encrypted request is not included in the request transaction). If the request transaction includes the symmetric key encrypted by the public key of the content storage, the content storage blockchain application 38b decrypts the symmetric key using the private key of the content storage. Further, the third party blockchain application 38b can calculate a hash of the stored encrypted request and compare the calculated hash to a hash included in the request transaction to verify that the stored encrypted request has not been altered.

In some embodiments, the request transaction is transmitted directly from the downstream entity computing device 4 to the content storage entity computing device 8 without use of an intermediary system, such as without use of the blockchain 40. The downstream entity computing device 4 may generate a request for access, for example, via a website or other network interface maintained by the content storage entity computing device 8. In such embodiments, steps 414-422 may be omitted and/or substituted with a single step including transmission of a request form the downstream entity computing device 4 to the content storage entity computing device 8.

After receiving the request for access, the content storage entity computing device 8 decrypts 424 the encrypted request. In some embodiments, the content storage entity computing device 8 decrypts 424 the encrypted request using the symmetric key. In other embodiments, the content storage entity computing device 8 can decrypt 424 the encrypted request using the private key associated with the content storage entity.

Additionally, the content storage entity computing device 8 can generate a challenge 426 to confirm the originator of the request transaction. For example, after retrieving the authentication token, the content storage entity computing device 8 can generate and transmit one challenges to validate that the downstream entity computing device 4 is associated with the downstream entity and/or the decentralized identifier embedded within the verifiable credential included in the authorization token. Although embodiments are illustrated with a challenge issued directly from the content storage entity computing device 8 to the downstream entity computing device 4, it will be appreciated that challenges may be generated and transmitted via the blockchain 40. In various embodiments, challenges may include, but are not limited to, operations that may only be decoded and/or completed through the use of a private key associated with the downstream entity and/or decentralized identifier.

The downstream entity computing device 4 may generate 428 a response to the challenge. For example, the response may include one or more data elements that may only be generated by the downstream entity computing device 4 associated with the decentralized identifier included in the authorization token/downstream verifiable credential. The downstream entity computing device 4 may transmit 430 the response to the content storage entity computing device 8, which may verify 432 the response.

The content storage entity computing device 8 may verify that the downstream entity and any intervening upstream entities are authorized to access information associated with the upstream entity. The content storage entity computing device 8 may utilize the authorization token and embedded verifiable credentials and/or decentralized identifiers to verify valid authorization, valid verifiable credentials, valid tokens, and/or otherwise validate each intermediate step in a chain between the downstream entity and the upstream entity. For example, the content storage entity computing device 8 may verify that the decentralized identifier included in the downstream verifiable credential is associated with the downstream entity computing device 4 and may further verify that the downstream verifiable credential and one or more embedded upstream verifiable credentials are currently valid.

In response to verifying authorization from the upstream entity, the content storage entity computing device 8 may prepare a reply 434 to the request providing access to a repository maintained by the content storage entity including information of and/or related to the upstream entity. For example, the content storage entity computing device 8 may authorize access to a content storage repository 10 utilizing the authorization token as an access credential. The content storage entity computing device 8 can automatically grant access to portions of a data repository, without requiring human actors to manually enter any data and/or requiring a centralized authority to issue additional credentials. After receiving the reply 434, the downstream entity computing device 4 can directly access 436 the content storage repository to retrieve 438 confidential information associated with the upstream entity.

If necessary, the content storage entity computing device 8 can access 440 the content storage repository to retrieve 442 confidential information and prepare a reply directly to the downstream entity computing device 4. For example, if an request asks the content storage entity to verify a particular piece of information, the content storage entity blockchain application 38b can compare the information in the request to information in the content storage entity's records. For example, the content storage entity blockchain application 38b can compare a hash of the information in the content storage entity's records (e.g., in the third party database 12) to the hash of the information in the request. If the hashes match, the content storage entity blockchain application 38b can determine that the content storage entity's information matches with the downstream entity's information. The reply 444 can include a flag indicating that the third party blockchain application 38b verifies the information in the request as accurate, and/or can include the hash of the information in the content storage entity's records so that the downstream entity blockchain application 32 can also verify that the hashes are identical. If the request asks the content storage entity to provide a particular piece of information, the content storage entity blockchain application 38b can retrieve 442 the information and include the information in the reply 444. More particularly, the content storage entity blockchain application 38b may calculate a hash of the information and include the hash in the reply rather than the information itself.

After preparing a reply including any requested verifications and/or information, the content storage entity computing device 8 encrypts the reply using a cryptographic algorithm. Similar to event 412, the content storage entity computing device 8 can encrypt the reply using the symmetric key that the content storage entity computing device 8 previously decrypted. In other implementations, the content storage entity computing device 8 can encrypt the reply using a public key of the downstream entity. The content storage entity computing device 8 can then store 444 the encrypted reply in the public storage system 44. The content storage entity computing device 8 may also calculate a hash of the encrypted reply using a cryptographic hash function. Similar to event 412, the content storage entity computing device 8 in some implementations refrains from storing the encrypted reply in the public storage system 44, and can instead include the encrypted reply in the reply transaction that the content storage entity computing device 8 generates below at event 446.

Next, the content storage entity computing device 8 generates 446 a reply transaction (i.e., a transaction to submit to the blockchain 40 associated with the reply). Similar to the request transaction, the reply transaction may include an indication of a location of the encrypted reply (e.g., a location of the encrypted reply stored in the public storage system 44), the hash of the encrypted reply, and/or the blockchain address of the downstream entity blockchain application 32. The content storage entity computing device 8 may also include a mechanism by which to decrypt the encrypted reply. However, if the content storage entity computing device 8 encrypted the reply using the previously-retrieved symmetric key, or the public key of the downstream entity, then the content storage entity computing device 8 may omit the decryption mechanism from the encrypted reply.

After signing the reply transaction with a private key associated with the content storage entity, the content storage entity computing device 8 submits 446 the reply transaction to the smart contract 48. The smart contract 48 validates 448 the reply, similar to the validation 416. In response to validating 448 the reply transaction, the smart contract 48 generates 450 an event that notifies the downstream entity blockchain application 32 of the existence of the new reply transaction addressed to the downstream entity blockchain application 32. Accordingly, the downstream entity blockchain application 32 detects the event and retrieves 452 the reply transaction from the blockchain 40.

The downstream entity computing device 4 uses the information in the reply transaction to retrieve 454 the encrypted reply. Based on the reply transaction, the downstream entity computing device 4 determines the location of the encrypted reply (e.g., the location in the public storage system 44, if the encrypted reply is not included in the reply transaction). The downstream entity computing device 4 can also verify whether the reply transaction was signed by the private key of the content storage entity by attempting to decrypt the signature using a public key of the content storage entity. Further, the downstream entity computing device 4 can calculate a hash of the stored encrypted reply and compare the calculated hash to a hash included in the reply transaction to verify that the stored encrypted reply has not been altered.

Using an appropriate key (e.g., the symmetric key or the private key of the downstream entity, depending on how the reply was encrypted), downstream entity computing device 4 can decrypt 450 the reply. The downstream entity computing device 4 can then process the reply. For example, the downstream entity computing device 4 can determine whether the content storage entity verified and/or provided information in the request and may display, via a display of the downstream entity computing device 4, an indication of any verifications and/or an indication of information included in the reply. The downstream entity computing device 4 may automatically determine that hashes in the reply conflicts with hashes in the request or hashes of information stored at the confirmation entity computing device 4, and generate a notification to indicate the conflict. Additional embodiments regarding methods and systems for exchanging confidential information via blockchain are included in co-owned U.S. Pat. No. 11,265,169, entitled “Systems and Methods for Exchanging Confidential Information via Blockchain,” issued 1 Mar. 2022, the disclosure of which is incorporated herein by reference in its entirety.

FIG. 5 illustrates a block diagram of a computing device 50, in accordance with some embodiments. In some embodiments, each of the confirmation entity computing device 4, the target entity computing device 6, and/or the third party computing device 10 in FIG. 1 may include the features shown in FIG. 5. Although FIG. 5 is described with respect to certain components shown therein, it will be appreciated that the elements of the computing device 50 may be combined, omitted, and/or replicated. In addition, it will be appreciated that additional elements other than those illustrated in FIG. 5 may be added to the computing device.

As shown in FIG. 5, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for exchanging confidential information using verifiable credentials including embedded decentralized identifiers, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with a corresponding blockchain application. For example, the user interface 66 may be a user interface for an application of a network environment operator that allows a user to view and interact with the operator's blockchain application. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

For example, the network may include, but is not limited to, any combination of a LAN, a MAN, a WAN, a mobile, a wired or wireless network, a private network, or a virtual private network. Moreover, it is understood that any number of client computers or display devices are supported and may be in communication with a data system.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of exemplary functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computing system for purposes of illustration only. One of ordinary skill in the art will readily recognize from the following discussion that alternative embodiments of the structures and methods illustrated herein may be employed without departing from the principles described herein.

Although the subject matter has been described in terms of exemplary embodiments, it is not limited thereto. Rather, the appended claims should be construed broadly, to include other variants and embodiments, which may be made by those skilled in the art.

What is claimed is:

1. A system for securely accessing information of an upstream entity by a downstream entity using a verifiable credential and decentralized identifier, comprising:
a non-transitory memory;
a processor communicatively coupled to the non-transitory memory, wherein the processor is configured to read a set of instructions to:
generate an authorization request for access to information pertaining to an upstream entity by a downstream entity, wherein the authorization request includes a decentralized identifier associated with the downstream entity;
transmit the authorization request to a content storage entity;
receive an authorization notification corresponding to the authorization request;
retrieve an authorization token based on at least a portion of the authorization notification, wherein the authorization token includes a verifiable credential generated by the upstream entity and incorporating the decentralized identifier;
generate a request transaction including a request to access the information pertaining to the upstream entity and the authorization token;
provide the request transaction to the content storage entity;
receive a verification challenge corresponding to the request transaction based on the verifiable credential;
transmit a response to the verification challenge; and
receive a reply transaction granting access to the information pertaining to the upstream entity.

2. The system of claim 1, wherein the authorization token enables access to the information pertaining to the upstream entity as stored in a database associated with the content storage entity.

3. The system of claim 1, wherein the request corresponds to a confirmation request for an audit of the upstream entity, and the content storage entity is an institution that maintains the information pertaining to the upstream entity.

4. The system of claim 1, wherein the processor is configured to decrypt the authorization token prior to generating the request transaction.

5. The system of claim 4, wherein the authorization token is decrypted using a symmetric encryption key.

6. The system of claim 1, wherein the processor is configured to encrypt the request prior to providing the request transaction.

7. The system of claim 6, wherein encrypting the request includes using a symmetric encryption key.

8. The system of claim 7, wherein generating the request transaction includes:
encrypting the symmetric encryption key using a public key associated with the content storage entity; and
including the encrypted symmetric encryption key in the request transaction.

9. The system of claim 7, wherein generating the request transaction includes generating the request transaction including an address, on a blockchain, of the upstream entity.

10. The system of claim 1, wherein the processor is configured to:
obtain a first hash value of the authorization token from the authorization notification;
calculate a second hash value the authorization token; and
compare the first hash value to the second hash value to verify the authorization token.

11. A computer-implemented method for securely accessing information of an upstream entity by a downstream entity using a verifiable credential and decentralized identifier, comprising:
generating an authorization request for access to information pertaining to an upstream entity by a downstream entity, wherein the authorization request includes a decentralized identifier associated with the downstream entity;
transmitting the authorization request to a content storage entity;
receiving an authorization notification corresponding to the authorization request;
retrieving an authorization token based on at least a portion of the authorization notification, wherein the authorization token includes a verifiable credential generated by the upstream entity and incorporating the decentralized identifier;
generating a request transaction including a request to access the information pertaining to the upstream entity and the authorization token;
transmitting the request transaction to the content storage entity;
receiving a verification challenge corresponding to the request transaction based on the verifiable credential;
transmitting a response to the verification challenge; and
receiving a reply transaction granting access to the information pertaining to the upstream entity.

12. The computer-implemented method of claim 11, wherein the authorization token enables access to the information pertaining to the upstream entity as stored in a database associated with the content storage entity.

13. The computer-implemented method of claim 11, wherein the request corresponds to a confirmation request for an audit of the upstream entity, and the content storage entity is an institution that maintains the information pertaining to the upstream entity.

14. The computer-implemented method of claim 11, comprising decrypting the authorization token prior to generating the request transaction.

15. The computer-implemented method of claim 14, wherein the authorization token is decrypted using a symmetric encryption key.

16. The computer-implemented method of claim 11, comprising encrypting the request prior to providing the request transaction.

17. The computer-implemented method of claim 16, wherein encrypting the request includes using a symmetric encryption key.

18. The computer-implemented method of claim 17, wherein generating the request transaction includes:
encrypting the symmetric encryption key using a public key associated with the content storage entity; and
including the encrypted symmetric encryption key in the request transaction.

19. The computer-implemented method of claim 17, wherein generating the request transaction includes generating the request transaction including an address, on a blockchain, of the upstream entity.

20. A non-transitory computer readable medium having instructions stored thereon, wherein the instructions, when executed by at least one processor, cause at least one device to perform operations for securely accessing information of an upstream entity by a downstream entity using a verifiable credential and decentralized identifier, the operations comprising:
generating an authorization request for access to information pertaining to an upstream entity by a downstream entity, wherein the authorization request includes a decentralized identifier associated with the downstream entity;
transmitting the authorization request to a content storage entity;
receiving an authorization notification corresponding to the authorization request;
retrieving an authorization token based on at least a portion of the authorization notification, wherein the authorization token includes a verifiable credential generated by the upstream entity and incorporating the decentralized identifier;
generating a request transaction including a request to access the information pertaining to the upstream entity and the authorization token;
transmitting the request transaction to the content storage entity;
receiving a verification challenge corresponding to the request transaction based on the verifiable credential;
transmitting a response to the verification challenge; and
receiving a reply transaction granting access to the information pertaining to the upstream entity.
